(19) United States
(12) Patent Application Publication
(10) Pub. No.: US 2025/0286192 A1
(43) Pub. Date: Sep. 11, 2025

(54) BATTERY MODULE

(71) Applicant: TOYOTA JIDOSHA KABUSHIKI KAISHA, Aichi-ken (JP)

(72) Inventor: Isamu HAYAKAWA, Okazaki-shi (JP)

(21) Appl. No.: 19/057,985

(22) Filed: Feb. 20, 2025

(30) Foreign Application Priority Data
Mar. 5, 2024 (JP) 2024-032884

(51) Int. Cl. H01M 50/242; H01M 50/202; H01M 50/249

(52) U.S. Cl. CPC H01M 50/242; H01M 50/202; H01M 50/249

(57) ABSTRACT

A battery module, including: an electrode body; a housing that covers a periphery of the electrode body; a protruding member that is disposed protruding from the electrode body and that is interposed in the housing; and an impact mitigation part at a position at which the housing and the protruding member face each other, the impact mitigation part mitigating an impact caused by a collision between the housing and the protruding member.

### CROSS-REFERENCE TO RELATED APPLICATION

This application is based on and claims priority under 35 USC 119 from Japanese Patent Application No. 2024-032884, filed on Mar. 5, 2024, the entire disclosure of which is incorporated by reference herein BACKGROUND

### TECHNICAL FIELD

The present disclosure relates to a battery module.

### RELATED ART

Conventionally, a battery module has been used which has an electrode body and a housing covering the periphery of the electrode body, and further has a voltage detection connector which is connected to the electrode body and which is arranged to protrude from the electrode body.

For example, Japanese Patent Application Laid-open No. 2023-036303 discloses an electrical storage device including a layered body formed from plural current collectors having an active material layer on a surface thereof, a pair of restraining members that apply a restraining load to the layered body in a layering direction, which is the direction in which the plural current collectors are layered, and a spacer positioned between adjacent current collectors in the layering direction and surrounding the active material layer positioned at the adjacent current collectors in the layering direction, the electrical storage device being formed partitioned at plural locations of the layered body by two current collectors adjacent to each other in the layering direction and the spacer, the plural current collectors including a terminal current collector positioned at an end of the layered body in the layering direction, among the respective surfaces of the terminal current collector, the surface at which the active material layer is positioned being referred to as a terminal inner surface, and a voltage detection line positioned on the terminal inner surface being provided.

Further, Japanese Patent Application Laid-open No. 2021-170500 discloses an electrical storage module including an electrode layered body formed from plural bipolar electrodes having a positive electrode active material layer on one surface of a current collection foil and a negative electrode active material layer on the other surface thereof, layered via a separator, and in the electrode layered body, a sealing part which is provided so as to cover a side surface of the bipolar electrodes along the layering direction, and which embeds a peripheral edge part of the current collection foil and a tab that protrudes from the peripheral edge part in a surface direction of the current collection foil, an opening part for exposing a tab of one current collection foil on an inner side of the outer surface being provided in the sealing part on an outer surface along the layering direction, and a female voltage detection connector, electrically connected to a part of the peripheral edge part of the one current collection foil exposed within the opening part, being inserted into the opening part.

In conventional battery modules, which have an electrode body, a housing covering the periphery of the electrode body, and a protruding member arranged so as to protrude from the electrode body and being interposed in the housing, when an impact is applied from the outside, the protruding member may be damaged. Specifically, when an impact is applied from the outside to the battery module, the electrode body and the protruding member may be displaced in the direction in which the impact is applied together with a part of the housing inside the battery module. Further, another part of the housing remains in the original position without displacement, and the protruding member that has been displaced collides with the housing, whereby damage has occurred at the protruding member. Therefore, it is desired to suppress the occurrence of damage to the protruding member even when an impact is applied to the battery module.

### SUMMARY

The present disclosure provides a battery module in which the occurrence of damage to a protruding member is suppressed even when an impact is applied.

A battery module of a first aspect of the present disclosure includes: an electrode body; a housing that covers a periphery of the electrode body; a protruding member that is disposed protruding from the electrode body and that is interposed in the housing; and an impact mitigation part at a position at which the housing and the protruding member face each other, the impact mitigation part mitigating an impact caused by a collision between the housing and the protruding member.

A battery module of a second aspect of the present disclosure is the battery module of the first aspect, in which the housing has, as the impact mitigation part, a slide member that slides in an opposite direction from a side of the protruding member at a time at which the housing and the protruding member have collided.

A battery module of a third aspect of the present disclosure is the battery module of the first aspect, in which the protruding member has, as the impact mitigation part, a slide member that slides in an opposite direction from a side of the housing at a time at which the housing and the protruding member have collided.

A battery module of a fourth aspect of the present disclosure is the battery module of the first aspect, in which the housing has, as the impact mitigation part, a deformation member that deforms in an opposite direction from a side of the protruding member at a time at which the housing and the protruding member have collided.

A battery module of a fifth aspect of the present disclosure is the battery module of the first aspect, in which the protruding member has, as the impact mitigation part, a deformation member that deforms in an opposite direction from a side of the housing at a time at which the housing and the protruding member have collided.

According to the present disclosure, a battery module is provided in which the occurrence of damage to a protruding member is suppressed even when an impact is applied.

### BRIEF DESCRIPTION OF THE DRAWINGS

Exemplary embodiments of the present disclosure will be described in detail based on the following figures, wherein:

FIG. 1A is a schematic top view showing a battery module according to a first aspect;

FIG. 1B is a schematic cross-sectional view showing a cross-section of FIG. 1A taken along line A′-A′;

FIG. 2 is a schematic top view for explaining the mechanism of the battery module according to the first aspect in a case in which an impact is applied thereto;

FIG. 3A is an enlarged view of the slide mechanism in the battery module according to the first aspect;

FIG. 3B is a side view of FIG. 3A;

FIG. 4A is an enlarged view of the slide mechanism in a variant example of the battery module according to the first aspect;

FIG. 4B is a side view of FIG. 4A;

FIG. 5A is an enlarged view of the slide mechanism in a variant example of the battery module according to the first aspect;

FIG. 5B is a side view of FIG. 5A;

FIG. 6A is an enlarged view of the slide mechanism in a variant example of the battery module according to the first aspect;

FIG. 6B is a side view of FIG. 6A;

FIG. 7 is a schematic top view showing a battery module according to a second aspect;

FIG. 8 is a schematic top view for explaining the mechanism of the battery module according to the second aspect in a case in which an impact is applied thereto;

FIG. 9 is a schematic top view showing a battery module according to a third aspect;

FIG. 10 is a schematic top view for explaining the mechanism of the battery module according to the third aspect in a case in which an impact is applied thereto;

FIG. 11A is an enlarged view of a deformation member in the battery module according to the third aspect;

FIG. 11B is a side view of FIG. 11A;

FIG. 11C is an enlarged view for explaining the mechanism of the deformation member in a case in which an impact is applied in the battery module according to the third aspect;

FIG. 12A is an enlarged view of a deformation member in a variant example of the battery module according to the third aspect;

FIG. 12B is a side view of FIG. 12A;

FIG. 13 is a schematic top view showing a battery module according to a fourth aspect;

FIG. 14 is a schematic top view for explaining the mechanism of the battery module according to the fourth aspect in a case in which an impact is applied thereto;

FIG. 15A is a schematic top view showing a conventional battery module;

FIG. 15B is a schematic cross-sectional view showing a cross-section of FIG. 15A taken along line B′-B′; and

FIG. 16 is a schematic top view for explaining the mechanism of a conventional battery module in a case in which an impact is applied.

### DETAILED DESCRIPTION

### <Battery Module>

A battery module according to an embodiment of the present disclosure has an electrode body, a housing covering the periphery of the electrode body, and a protruding member disposed protruding from the electrode body and interposed in the housing. Further, an impact mitigation part, which mitigates an impact due to a collision between the housing and the protruding member, is provided at a position at which the housing and the protruding member face each other.

In conventional battery modules, when an impact (for example, an impact due to an automobile accident in the case of a battery module used in an in-vehicle battery) is applied from the outside, in some cases, the electrode body and the protruding member are displaced in the direction in which the impact is applied together with a part of the housing, in the battery module. Further, since the other part of the housing remains in its original position without being displaced, damage to the protruding member may occur as a result of collision of the displaced protruding member with respect to the housing that has remained in place.

In contrast, a battery module according to an embodiment of the present disclosure has an impact mitigation part, which mitigates an impact due to a collision between the housing and the protruding member, at a position in which the housing and the protruding member face each other. As a result, even in a case in which an impact is applied to the battery module, displacement of the electrode body and the protruding member occurs in the battery module, and the protruding member collides with a part of the housing which has remained in its original position without being displaced, the impact mitigation part mitigates the impact caused by the collision between the housing and the protruding member. As a result, the occurrence of damage to the protruding member is suppressed.

Examples of the protruding member include a voltage detection connector electrically connected to an electrode body (specifically, a current collection foil, or the like).

Hereinafter, a configuration of a battery module according to an embodiment of the present disclosure will be described with reference to the drawings. In the description of the drawings, the same reference numerals are used for the same or equivalent elements, and duplicated descriptions thereof will be omitted.

### (First Aspect)

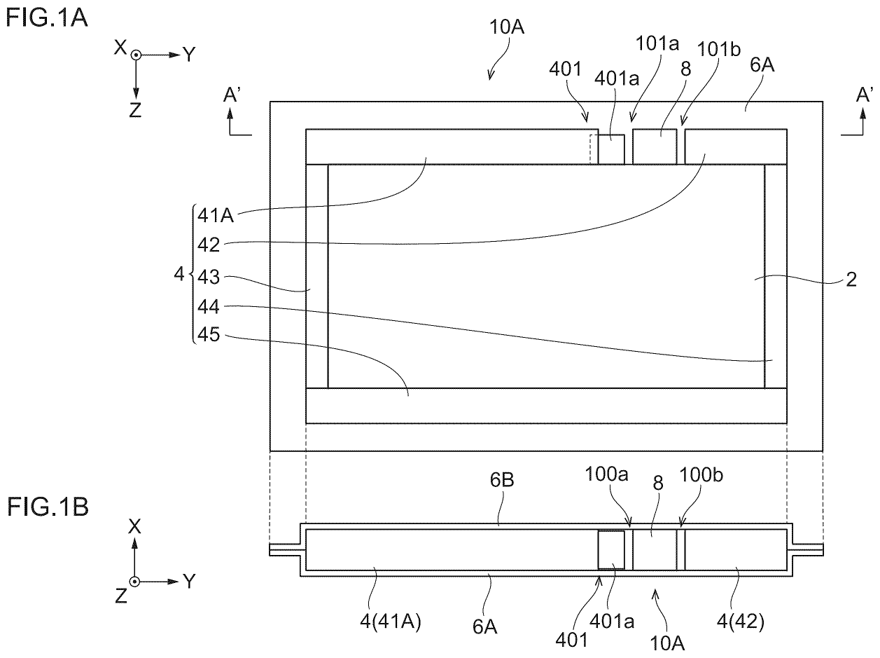

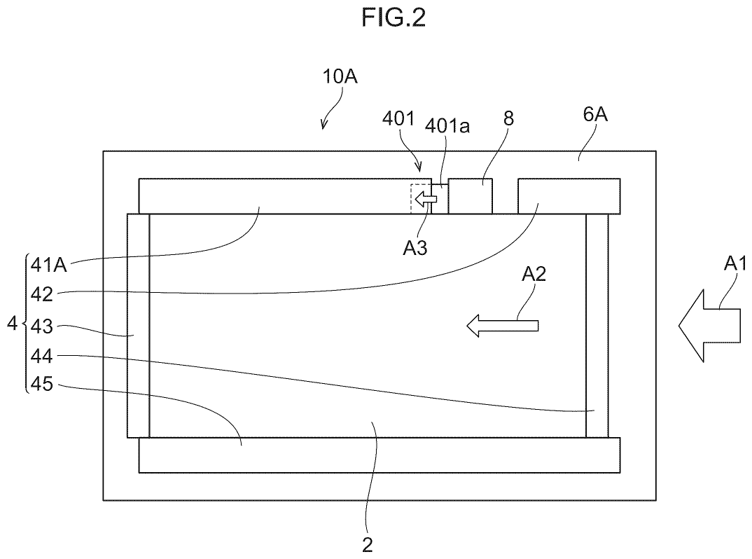

FIG. 1A is a schematic top view showing a part of a battery module according to a first aspect, and FIG. 1B is a schematic cross-sectional view showing a cross-section along line A′-A′ in FIG. 1A. Note that the battery module 10A shown in FIGS. 1A and 1B is sealed by a pair of laminate exterior bodies consisting of a first laminate film 6A and a second laminate film 6B that is paired with the first laminate film 6A. However, in FIG. 1A, in order to show the internal structure of the battery module in a manner that is easily understood, the second laminate film 6B is omitted. The same applies to FIGS. 2, 7 to 10, 13, 14, 15A, and 16.

The battery module 10A is provided with an electrode laminate 2 as an example of an electrode body, and a resin housing 4 which seals the electrode laminate 2. The housing 4 covers the periphery of the electrode laminate 2 and is arranged between the electrode laminate 2 and the laminate exterior body configured by the first laminate film 6A and the second laminate film 6B. The electrode laminate 2 is configured by plural electrodes laminated via a separator. These electrodes may have, for example, a configuration including a laminate of plural bipolar electrodes, a negative electrode termination electrode, and a positive electrode termination electrode.

The laminate exterior body configured by the first laminate film 6A and the second laminate film 6B houses the electrode laminate 2 and the housing 4. The end portions of the first laminate film 6A and the second laminate film 6B are welded, and the interior thereof is in a sealed state. As the laminate film, for example, a film in which a resin layer is formed on both surfaces of a metal layer can be used.

An electrode body such as the electrode laminate 2 has, for example, a substantially rectangular shape in the thickness direction of the electrode body (as viewed in the direction of arrow X in FIGS. 1A and 1). Further, the rectangular electrode body can have, for example, a size such that the length of the side in the rectangular shape is 1000 mm or more and the width is 10000 mm.

The housing 4 is formed in a rectangular tubular shape as a whole. The housing 4 is arranged at the side surfaces of the electrode laminate 2. In other words, the housing 4 is arranged so as to surround the periphery of the electrode laminate 2 in a direction orthogonal to the thickness direction of the electrode laminate 2 (the direction of arrow X in FIGS. 1A and 1). The housing 4 is configured by five housing members 41A, 42, 43, 44, 45 so as to cover the side surfaces of the rectangular electrode laminate 2. The five housing members 41A, 42, 43, 44, 45 may or may not be welded at the respective contact parts.

Note that the housing 4 may be configured by, for example, an inner housing arranged to cover one circumference of the side surface of the electrode laminate 2 and an outer housing which surrounds the inner housing from the outside.

For example, an electrolyte is impregnated into the separator, the positive electrode, and the negative electrode configuring the electrode laminate 2.

The electrode laminate 2 is provided with a voltage detection connector 8 as a protruding member. The voltage detection connector 8 is electrically connected to the current collection foil of the electrode laminate 2, and is used for detecting the voltage of each electrode in the electrode laminate 2. The voltage detection connector 8 is arranged so as to protrude from the electrode laminate 2. The voltage detection connector 8 is arranged so as to be interposed between the housing member 41A and the housing member 42 configuring the housing 4. In other words, the housing 4, which is integrally arranged so as to surround the periphery of the electrode laminate 2, has an interrupted shape, instead of being connected, at a position at which the voltage detection connector 8, which is an example of a protruding member, is disposed.

However, the housing member 41A and the housing member 42 may be integrally formed so as to cover the voltage detection connector 8. In such a case, the voltage detection connector 8, which is an example of a protruding member, is interposed and arranged between the housing member 41A and the housing member 42, which have a shape that is connected so as to cover the voltage detection connector 8.

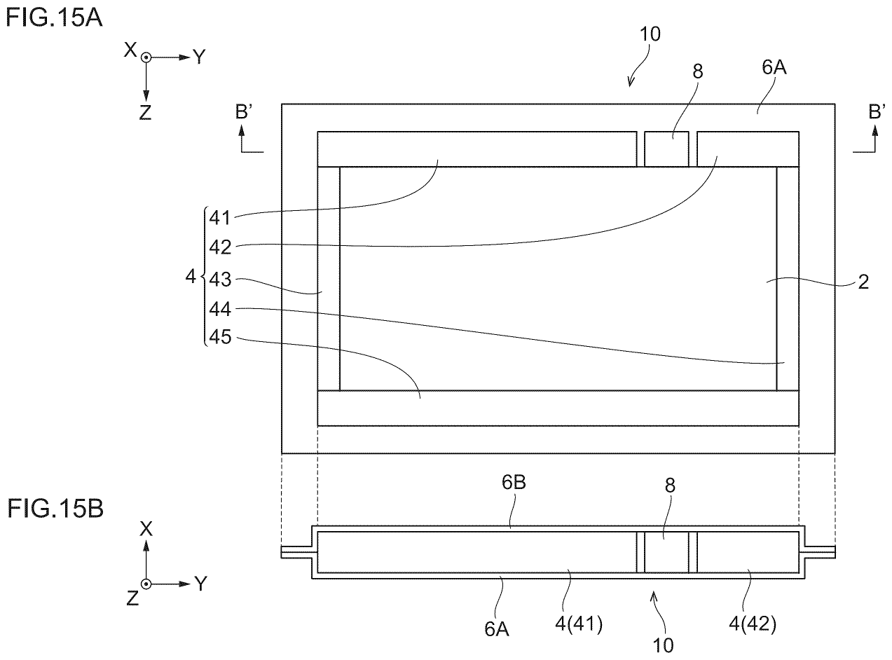

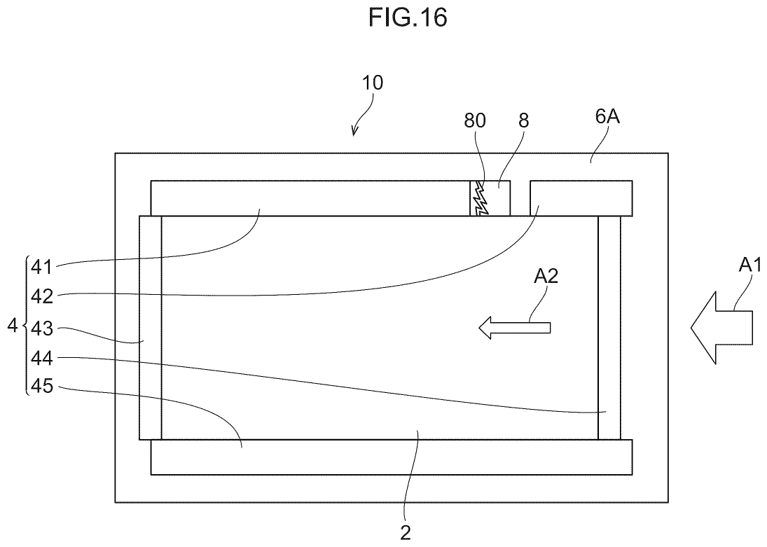

Here, the structure of a conventional battery module will be described. FIG. 15A is a schematic top view showing a part of a conventional battery module, and FIG. 15B is a schematic cross-sectional view showing a cross section taken along line B′-B′ of FIG. 15A. FIG. 16 is a schematic top view for explaining a problem that occurs when an impact is applied to the battery module shown in FIG. 15A from the direction of arrow A1.

The battery module 10 shown in FIGS. 15A and 15B includes an electrode laminate 2 and a housing 4 that covers the periphery of the electrode laminate 2. The electrode laminate 2 and the housing 4 are housed in a laminate exterior body configured by the first laminate film 6A and the second laminate film 6B. The housing 4 is configured by five housing members 41, 42, 43, 44, 45 so as to cover the side surfaces of the rectangular electrode laminate 2. The electrode laminate 2 is provided with a voltage detection connector 8 as a protruding member. The voltage detection connector 8 is arranged so as to protrude from the electrode laminate 2. The voltage detection connector 8 is arranged so as to be interposed between the housing member 41 and the housing member 42.

Here, as shown in FIG. 16, a case in which an impact is applied to the conventional battery module 10 from the direction of arrow A1, as shown in FIG. 16, will be described. Examples of the impact from the direction of arrow A1 include an impact due to an automobile accident when the battery module 10 is a battery module used for an in-vehicle battery.

When an impact is applied to the battery module 10 from the direction of arrow A1, the electrode laminate 2 and the housing members 43, 44 are displaced in the direction of arrow A2 with respect to the housing members 41, 42, 45. As a result, the voltage detection connector 8 is also displaced in the direction of arrow A2. As a result, the voltage detection connector 8 collides with the housing member 41, and damage 80 may occur in the voltage detection connector 8.

Therefore, it is desired to suppress the occurrence of damage 80 in the voltage detection connector 8, as the protruding member, even when an impact is applied to the battery module 10.

In contrast, in the battery module 10A of the first aspect shown in FIGS. 1A and 1, the housing member 41A has a slide mechanism 401 at a position 101a, which faces the voltage detection connector 8. The slide mechanism 401 of the housing member 41A has a slide member 401a. As shown in FIG. 2, when the housing member 41A collides with the voltage detection connector 8, the slide member 401a slides in the direction of arrow A3; that is, in the opposite direction from the side of the voltage detection connector 8. Therefore, even in a case in which an impact is applied to the battery module 10A from the direction of arrow A1 and the electrode laminate 2, the housing members 43, 44, and the voltage detection connector 8 are displaced in the direction of arrow A2, when the voltage detection connector 8 collides with the housing member 41A, the slide member 401a slides in the direction of arrow A3. In other words, the slide mechanism 401 having the slide member 401a configures an impact mitigation part. As a result, an impact due to collision between the voltage detection connector 8 and the housing member 41A is mitigated, and the occurrence of damage in the voltage detection connector 8, as the protruding member, is suppressed.

In the battery module according to the first aspect shown in FIGS. 1A and 1, the housing 4 and the voltage detection connector 8, as the protruding member, face each other at the two positions 101a and 101b. Further, among these two opposing positions, an aspect in which the slide member 401a is provided at the position 101a is shown. However, the battery module according to the embodiment of the present disclosure is not limited to this aspect, and it is sufficient that the slide member, as the impact mitigation part, be provided at at least one of the positions at which the housing and the protruding member face each other.

For example, in FIG. 1A and FIG. 1B, the slide member may be provided only at the position 101b among the positions 101a and 101b at which the housing 4 and the voltage detection connector 8 face each other (in other words, the housing member 42 in FIGS. 1A and 1B may have a slide member at the position 101b facing the voltage detection connector 8). When the slide member is provided at the position 101b, when an impact is applied to the battery module from the opposite side from the arrow A1 shown in FIG. 2 (that is, when an impact is applied to the battery module from the left side in FIG. 2), the impact due to collision between the voltage detection connector 8 and the housing member 42 is mitigated by the slide member, and the occurrence of damage in the voltage detection connector 8, as the protruding member, is suppressed.

Further, in FIG. 1A and FIG. 1B, a slide member may be provided at both of the positions 101a and 101b at which the housing 4 and the voltage detection connector 8 face each other (in other words, the housing members 41A and 42 in FIGS. 1A and 1B may have slide members at each of positions 101a and 101b, which face the voltage detection connector 8). By providing the slide member at positions 101a and 101b, in either of a case in which an impact is applied to the battery module from the direction of arrow A1 shown in FIG. 2 or a case in which an impact is applied from the opposite side from the arrow A1 (i.e., in a case in which an impact is applied to the battery module from the left side in FIG. 2), the impact due to collision between the voltage detection connector 8 and the housing member 41A or due to collision between the voltage detection connector 8 and the housing member 42 is mitigated by the slide members, and the occurrence of damage in the voltage detection connector 8, as the protruding member, is suppressed.

Here, the shape of the slide mechanism 401 and the like will be described.

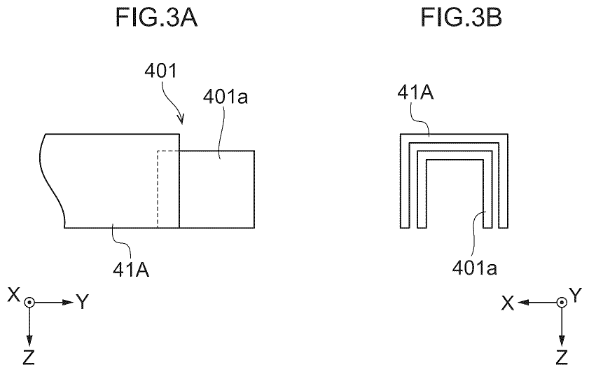

FIG. 3A is an enlarged view of a part of the slide mechanism 401 in the battery module 10A of the first aspect shown in FIG. 1A, and FIG. 3B is a side view of FIG. 3A from the right direction. As shown in FIGS. 3A and 3B, in the slide mechanism 401, a slide member 401a that is hollow and has no wall on the side of the electrode laminate 2 is arranged inside the housing member 41A, which is hollow and has no wall on the electrode laminate 2 side. When the voltage detection connector 8 collides with the slide member 401a owing to an impact from the direction of arrow A1, the slide member 401a slides so as to enter the inside of the housing member 41A.

### Stopper

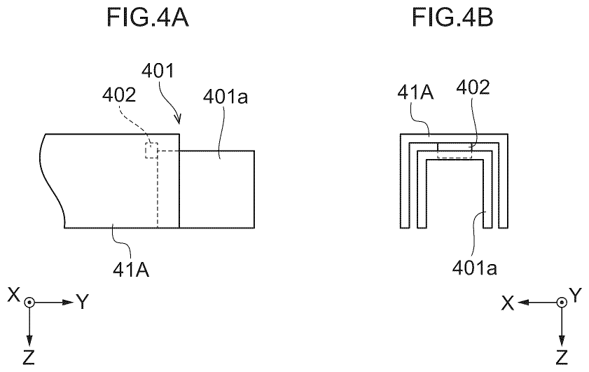

As shown in FIGS. 4A and 4B, the slide mechanism 401 preferably has a stopper 402. The stopper 402 has a function of fixing the slide member 401a so as not to move in a normal state; that is, in a state in which no impact is applied to the battery module from the direction of the arrow A1. Furthermore, when an impact from the direction of arrow A1 is applied to the battery module and the voltage detection connector 8 collides with the slide member 401a, by breaking the stopper 402, for example, the fixing of the slide member 401a by the stopper 402 is released, and the slide member 401a slides so as to enter the inside of the housing member 41A.

### Rail

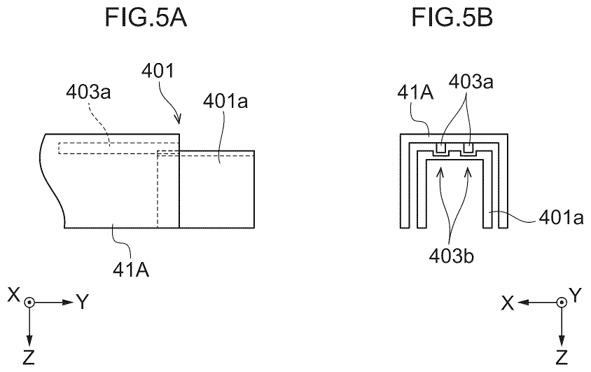

As shown in FIGS. 5A and 5B, in the slide mechanism 401, it is preferable that the housing member 41A have rails 403a and the slide member 401a have grooves 403b along the rails 403a. By having the rails 403a and the grooves 403b along the rails 403a, when an impact from the direction of arrow A1 is applied to the battery module and the voltage detection connector 8 collides with the slide member 401a, the slide member 401a smoothly slides toward the inside of the housing member 41A, whereby impact due to the collision between the voltage detection connector 8 and the housing member 41A is further mitigated.

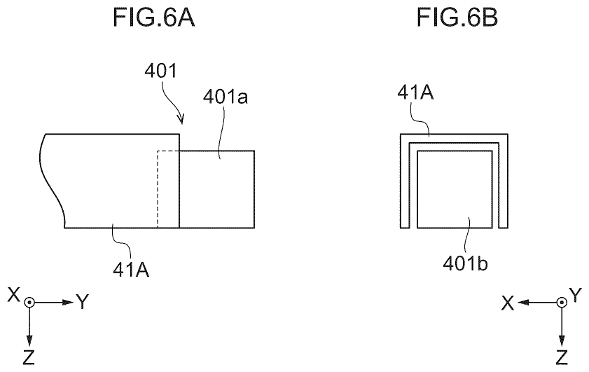

Note that the aspect of the slide member provided in the slide mechanism 401 is not limited to the aspect shown in FIGS. 3A and 3B. For example, as shown in FIGS. 6A and 6B, the slide member may be a solid and columnar slide member 401b.

### (Second Aspect)

Next, a second aspect in which the voltage detection connector, as the protruding member, has the slide mechanism will be described.

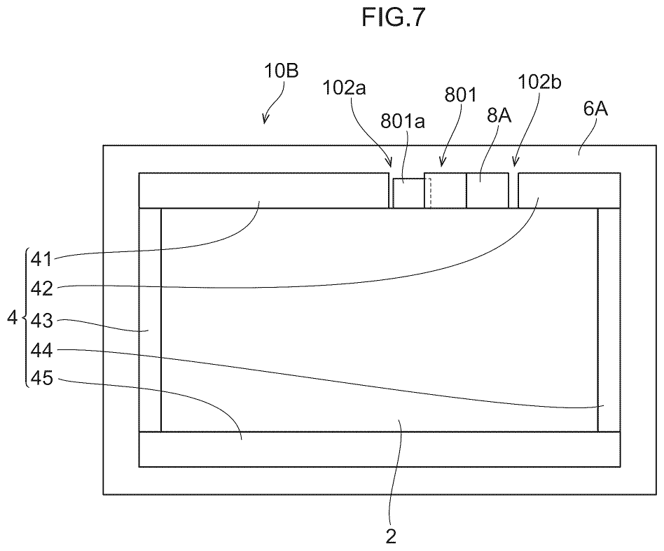

FIG. 7 is a schematic top view showing a part of a battery module according to a second aspect. Note that parts other than the slide mechanism 801 have the same configuration as the battery module according to the first aspect shown in FIGS. 1A and 1, and therefore, description thereof will be omitted here.

In a battery module 10B of the second aspect shown in FIG. 7, a voltage detection connector 8A, as a protruding member, is provided on the electrode laminate 2. The voltage detection connector 8A is electrically connected to the current collection foil of the electrode laminate 2, and is used for detecting the voltage of each electrode in the electrode laminate 2. The voltage detection connector 8A is arranged so as to protrude from the electrode laminate 2. The voltage detection connector 8A is arranged so as to be interposed between the housing member 41 and the housing member 42 configuring the housing 4. In other words, the housing 4, which is integrally arranged so as to surround the periphery of the electrode laminate 2, has an interrupted shape, instead of being continuous, at a position at which the voltage detection connector 8A, which is an example of a protruding member, is arranged.

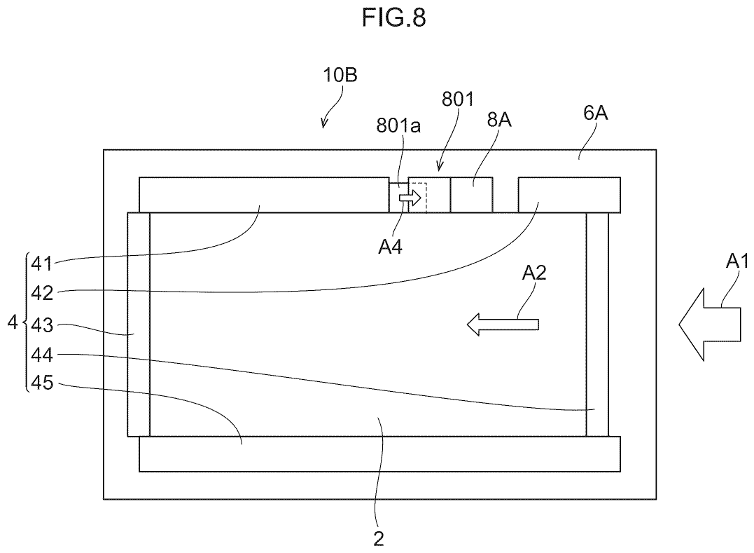

In the battery module 10B, the voltage detection connector 8A, as the protruding member, has the slide mechanism 801 at a position 102a that faces the housing member 41. The slide mechanism 801 in the voltage detection connector 8A has a slide member 801a. As shown in FIG. 8, when the housing member 41 collides with the voltage detection connector 8A, the slide member 801a slides in the direction of arrow A4; that is, in the opposite direction from the side of the housing member 41. Therefore, even when an impact is applied to the battery module 10B from the direction of arrow A1, and the electrode laminate 2, the housing members 43, 44, and the voltage detection connector 8A are displaced in the direction of arrow A2, when the voltage detection connector 8A collides with the housing member 41, the slide member 801a slides in the direction of arrow A4. In other words, the slide mechanism 801 having the slide member 801a configures an impact mitigation part. As a result, impact due to collision between the voltage detection connector 8A and the housing member 41 is reduced, and the occurrence of damage in the voltage detection connector 8A, as the protruding member, is suppressed.

In the battery module according to the second aspect shown in FIG. 7, the housing 4 and the voltage detection connector 8A, as the protruding member, face each other at the two positions 102a and 102b. Further, among these two facing positions, an aspect in which the slide member 801a is provided at the position 102a is shown. However, the battery module according to the embodiment of the present disclosure is not limited to this aspect, and it is sufficient that the slide member, as the impact mitigation part, be provided at at least one of the positions at which the housing and the protruding member face each other. For example, in FIG. 7, a slide member may be provided only at the position 102b among the positions 102a and 102b at which the housing 4 and the voltage detection connector 8A face each other (in other words, the voltage detection connector 8A in FIG. 7 may have a slide member at the position 102b facing the housing member 42). When the slide member is provided at the position 102b, when an impact is applied to the battery module from the opposite side from the arrow A1 shown in FIG. 8 (that is, when an impact is applied to the battery module from the left side in FIG. 8), the impact due to collision between the voltage detection connector 8A and the housing member 42 is mitigated by the slide member, and the occurrence of damage in the voltage detection connector 8A, as the protruding member, is suppressed.

Further, in FIG. 7, a slide member may be provided at both the positions 102a and 102b at which the housing 4 and the voltage detection connector 8A face each other (in other words, the voltage detection connector 8A in FIG. 7 may have a slide member at each of the position 102a facing the housing member 41 and the position 102b facing the housing member 42). By providing the slide member at positions 102a and 102b, in either of a case in which an impact is applied to the battery module from the direction of arrow A1 shown in FIG. 8, or a case in which an impact is applied from the opposite side from the arrow A1 (i.e., in a case in which an impact is applied to the battery module from the left side in FIG. 8), the impact due to collision between the voltage detection connector 8A and the housing member 41 or collision between the voltage detection connector 8A and the housing member 42 is mitigated by the slide member, and the occurrence of damage in the voltage detection connector 8A, as the protruding member, is suppressed.

Note that, similarly to the slide mechanism 401 shown in FIGS. 3A and 3B, in the slide mechanism 801, a slide member 801a that is hollow and has no wall on the side of the electrode laminate 2 is arranged inside the voltage detection connector 8A, which is hollow and has no wall on the side of the electrode laminate 2. When the voltage detection connector 8A collides with the slide member 801a owing to an impact from the direction of arrow A1, the slide member 801a slides so as to enter the inside of the voltage detection connector 8A. Note that the aspect of the slide member provided at the slide mechanism 801 is not particularly limited. For example, similarly to the slide member 401b shown in FIGS. 6A and 6B, a solid and columnar slide member may be used.

### Stopper

Similarly to the slide mechanism 401 shown in FIGS. 4A and 4B, the slide mechanism 801 preferably has a stopper. The stopper has a function of fixing the slide member 801a so as not to move in a normal state; that is, in a state in which no impact is applied to the battery module from the direction of arrow A1. Furthermore, when an impact from the direction of arrow A1 is applied to the battery module and the slide member 801a collides with the housing member 41, the fixing of the slide member 801a by the stopper is released by, for example, the stopper being destroyed, and the slide member 801a slides so as to enter the inside of the voltage detection connector 8A.

### Rail

Similarly to the slide mechanism 401 shown in FIGS. 5A and 5B, in the slide mechanism 801, it is preferable that the voltage detection connector 8A has a rail and the slide member 801a has a groove along the rail. By providing a rail and a groove along the rail, when an impact from the direction of arrow A1 is applied to the battery module and the slide member 801a collides with the housing member 41, the slide member 801a slides smoothly toward the inside of the voltage detection connector 8A, and the impact caused by the collision between the voltage detection connector 8A and the housing member 41 is further mitigated.

### (Third Aspect)

Next, a third aspect in which the housing has a deformation member will be described.

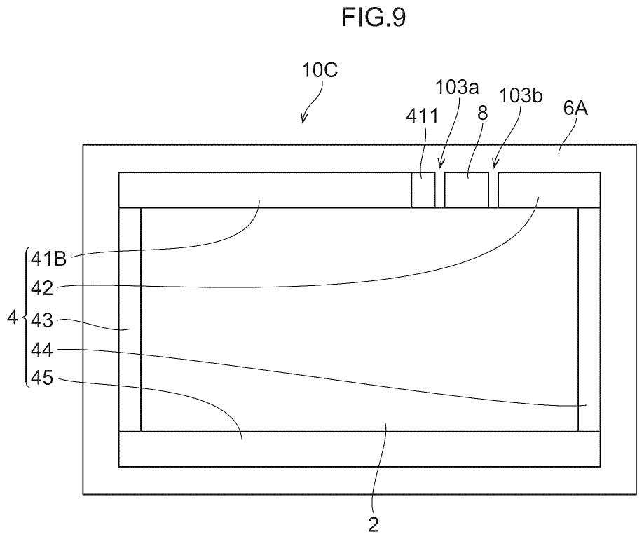

FIG. 9 is a schematic top view showing a part of a battery module according to a third aspect. Note that for portions other than the housing member 41B having the deformation member 411, since the battery module has the same configuration as the battery module according to the first aspect shown in FIGS. 1A and 1, description thereof will be omitted here.

In the battery module 10C of the third aspect shown in FIG. 9, a voltage detection connector 8, as a protruding member, is provided on the electrode laminate 2. The voltage detection connector 8 is electrically connected to the current collection foil of the electrode laminate 2, and is used for detecting the voltage of each electrode in the electrode laminate 2. The voltage detection connector 8 is arranged so as to protrude from the electrode laminate 2. The voltage detection connector 8 is arranged so as to be interposed between the housing member 41B and the housing member 42 configuring the housing 4. In other words, the housing 4, which is integrally arranged so as to surround the periphery of the electrode laminate 2, has an interrupted shape, instead of being continuous, at a position at which the voltage detection connector 8, which is an example of a protruding member, is disposed.

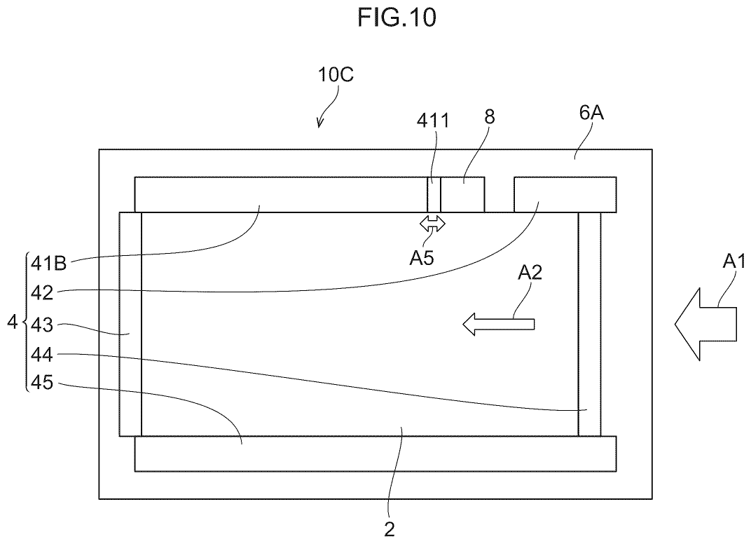

In the battery module 10C, the housing member 41B has a deformation member 411 at a position 103a that faces the voltage detection connector 8. As shown in FIG. 10, when the housing member 41B collides with the voltage detection connector 8, the deformation member 411 is compressed as indicated by arrow A5 and deforms in the opposite direction from the side of the voltage detection connector 8. Therefore, even when an impact is applied to the battery module 10C from the direction of arrow A1, and the electrode laminate 2, the housing members 43, 44, and the voltage detection connector 8 are displaced in the direction of arrow A2, when the voltage detection connector 8 collides with the housing member 41B, the deformation member 411 is compressed and deforms as indicated by arrow A5. In other words, the deformation member 411 configures an impact mitigation part. As a result, impact due to the collision between the voltage detection connector 8 and the housing member 41B is reduced, and the occurrence of damage in the voltage detection connector 8, as the protruding member, is suppressed.

In the battery module according to the third aspect shown in FIG. 9, the housing 4 and the voltage detection connector 8, as the protruding member, face each other at the two positions 103a and 103b. Further, among the two facing positions, an aspect in which the deformation member 411 is provided at the position 103a is shown. However, the battery module according to the embodiment of the present disclosure is not limited to this aspect, and it is sufficient that the deformation member as the impact mitigation part be provided at least at one of the positions at which the housing and the protruding member face each other.

For example, in FIG. 9, the deformation member may be provided only at the position 103b among the positions 103a and 103b at which the housing 4 and the voltage detection connector 8 face each other (in other words, the housing member 42 in FIG. 9 may have the deformation member at the position 103b facing the voltage detection connector 8). When the deformation member is provided at the position 103b, when an impact is applied to the battery module from the opposite side from the arrow A1 shown in FIG. 10 (that is, when an impact is applied to the battery module from the left side in FIG. 10), the impact due to collision between the voltage detection connector 8 and the housing member 42 is mitigated by the deformation member, and the occurrence of damage in the voltage detection connector 8, as the protruding member, is suppressed.

Further, in FIG. 9, a deformation member may be provided at both of the positions 103a and 103b at which the housing 4 and the voltage detection connector 8 face each other (in other words, the deformation member may be provided at the position 103a at which the housing member 41B faces the voltage detection connector 8 and at the position 103b at which the housing member 42 faces the voltage detection connector 8 in FIG. 9). By providing the deformation member at the positions 103a and 103b, in either of a case in which an impact is applied to the battery module from the direction of arrow A1 shown in FIG. 10, or a case in which an impact is applied from the opposite side from the arrow A1 (i.e., in FIG. 10, a case in which an impact is applied to the battery module from the left side), the impact due to the collision between the voltage detection connector 8 and the housing member 41B or the collision between the voltage detection connector 8 and the housing member 42 is mitigated by the deformation member, and the occurrence of damage in the voltage detection connector 8, as the protruding member, is suppressed.

Here, the deformation member 411 will be described.

### Bellows Shape

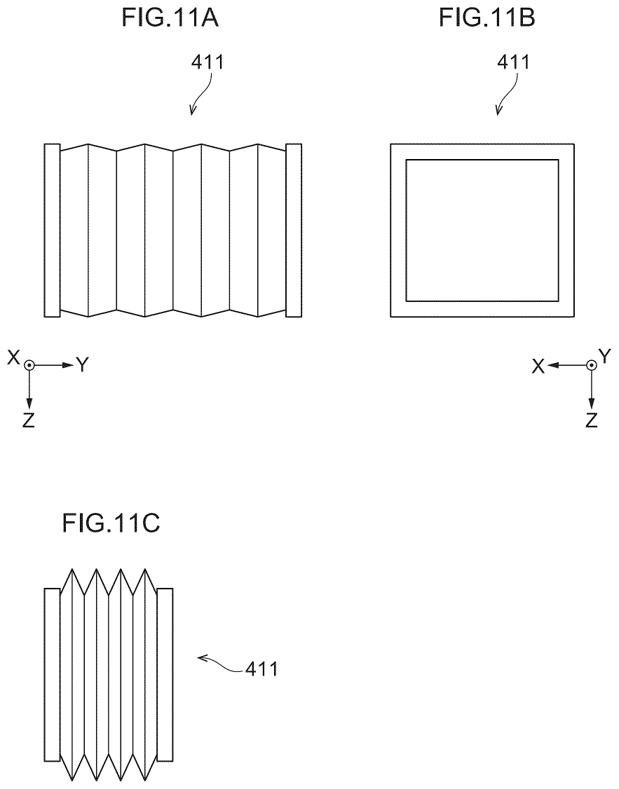

FIG. 11A is an enlarged view showing the deformation member 411 included in the battery module 10C of the third aspect shown in FIG. 9, and FIG. 11B is a side view of FIG. 11A from the right direction. As shown in FIGS. 11A and 11B, examples of the deformation member 411 include a bellows-shaped and hollow prismatic columnar member. As a result of the deformation member 411 being bellows-shaped, even when an impact is applied to the battery module 10C from the direction of arrow A1 and the voltage detection connector 8 collides with the housing member 41B, the bellows-shaped part of the deformation member 411 is compressed and deforms as shown in FIG. 11C. As a result, the impact due to the collision between the voltage detection connector 8 and the housing member 41B is mitigated.

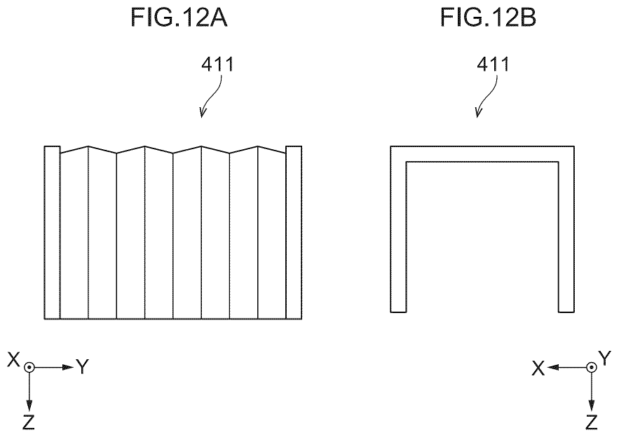

Note that the aspect in which the deformation member 411 is a bellows-shaped member is not limited to the aspect shown in FIGS. 11A and 11B. For example, as shown in FIGS. 12A and 12B, the deformation member 411 may be a member having a bellows shape and a hollow shape and having no wall on the electrode laminate 2 side.

### Elastic Body

Examples of the deformation member 411 include an elastic body. As a result of the deformation member 411 being an elastic body, even when an impact is applied to the battery module 10C from the direction of arrow A1 and the voltage detection connector 8 collides with the housing member 41B, the elastic body, as the deformation member 411, is compressed owing to elastic deformation, whereby the impact due to the collision between the voltage detection connector 8 and the housing member 41B is mitigated.

Examples of the elastic body include rubber and thermosetting elastomers.

Examples of the rubber include: natural rubber, nitrile rubber, acrylic rubber, isoprene rubber, styrene rubber, butadiene rubber, ethylene propylene diene rubber, ethylene vinyl acetate rubber, chlorinated polyethylene rubber, epichlorohydrin rubber, polysulfide rubber, styrene butadiene rubber, chloroprene rubber, acrylonitrile rubber, butyl rubber, ethylene propylene rubber, urethane rubber, silicone rubber, fluororubber, and chlorosulfonated polyethylene rubber.

Examples of the thermosetting elastomer include: styrene elastomers, olefinic elastomers, ester-based elastomers, urethane elastomers, amide-based elastomers, hydrogenated elastomers, vinyl chloride-based elastomers, nitrile-based elastomers, fluoroelastomers, chlorinated polyethylene elastomers, polybutadiene elastomers, transelastomer, and silicone-based elastomers.

### (Fourth Aspect)

Next, a fourth aspect in which the voltage detection connector, as the protruding member, has a deformation member will be described.

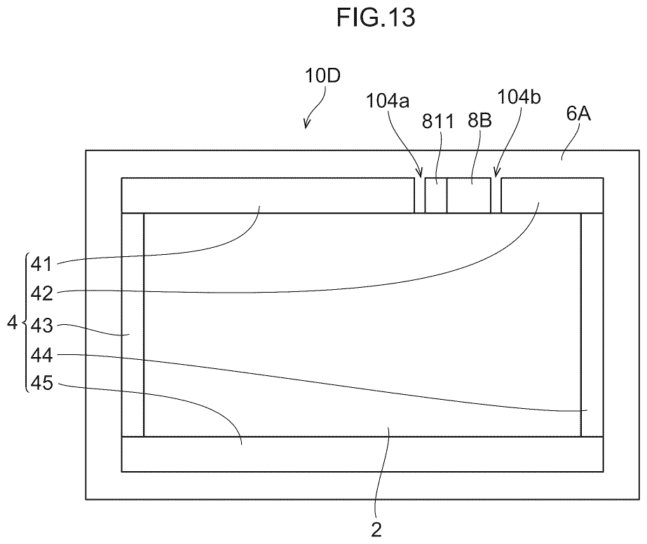

FIG. 13 is a schematic top view showing a part of a battery module according to a fourth aspect. Note that parts other than the deformation member 811 have the same configuration as the battery module according to the third aspect shown in FIG. 9, and therefore, description thereof will be omitted here.

In the battery module 10D of the fourth aspect shown in FIG. 13, the electrode laminate 2 is provided with a voltage detection connector 8B as a protruding member. The voltage detection connector 8B is electrically connected to the current collection foil of the electrode laminate 2, and is used for detecting the voltage of each electrode in the electrode laminate 2. The voltage detection connector 8B is arranged so as to protrude from the electrode laminate 2. The voltage detection connector 8B is arranged so as to be interposed between the housing member 41 and the housing member 42 configuring the housing 4. In other words, the housing 4, which is integrally arranged so as to surround the periphery of the electrode laminate 2, has an interrupted shape instead of being continuous at a position at which the voltage detection connector 8B, which is an example of a protruding member, is arranged.

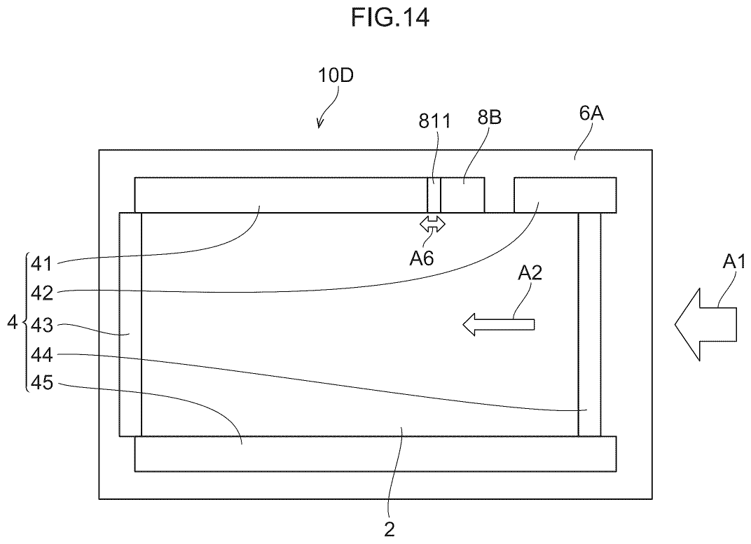

In the battery module 10D, the voltage detection connector 8B, as the protruding member, has the deformation member 811 at a position 104a facing the housing member 41. As shown in FIG. 14, when the housing member 41 collides with the voltage detection connector 8B, the deformation member 811 is compressed as indicated by an arrow A6 and deforms in the opposite direction from the side of the housing member 41. Therefore, even when an impact is applied to the battery module 10D from the direction of arrow A1 and the electrode laminate 2, the housing members 43, 44, and the voltage detection connector 8B are displaced in the direction of arrow A2, when the voltage detection connector 8B collides with the housing member 41, the deformation member 811 is compressed and deforms as indicated by arrow A6. In other words, the deformation member 811 configures an impact mitigation part. As a result, the impact due to the collision between the voltage detection connector 8B and the housing member 41 is reduced, and the occurrence of damage in the voltage detection connector 8B, as the protruding member, is suppressed.

In the battery module according to the fourth aspect shown in FIG. 13, the housing 4 and the voltage detection connector 8B, as the protruding member, face each other at the two positions 104a and 104b. Further, among these two facing positions, an embodiment in which the deformation member 811 is provided at the position 104a is shown. However, the battery module according to the embodiment of the present disclosure is not limited to this aspect, and it is sufficient that the deformation member as the impact mitigation part be provided at least at one of the positions at which the housing and the protruding member face each other.

For example, in FIG. 13, the deformation member may be provided only at the position 104b among the positions 104a and 104b at which the housing 4 and the voltage detection connector 8B face each other (in other words, the voltage detection connector 8B in FIG. 13 may have a deformation member at the position 104b facing the housing member 42). When the deformation member is provided at the position 104b, when an impact is applied to the battery module from the opposite side from the arrow A1 shown in FIG. 14 (that is, when an impact is applied to the battery module from the left side in FIG. 14), the impact caused by the collision between the voltage detection connector 8B and the housing member 42 is mitigated by the deformation member, and the occurrence of damage in the voltage detection connector 8B, as the protruding member, is suppressed.

In FIG. 13, a deformation member may be provided at both of the positions 104a and 104b at which the housing 4 and the voltage detection connector 8B face each other (in other words, the voltage detection connector 8B in FIG. 13 may have deformation members at the position 104a facing the housing member 41B and at the position 104b facing the housing member 42, respectively). By providing the deformation member at the positions 104a and 104b, in either of a case in which an impact is applied to the battery module from the direction of arrow A1 shown in FIG. 14 or a case in which an impact is applied from the opposite side from the arrow A1 (i.e., a case in which an impact is applied to the battery module from the left side in FIG. 14), the impact due to the collision between the voltage detection connector 8B and the housing member 41B or the collision between the voltage detection connector 8B and the housing member 42 is mitigated by the deformation member, and the occurrence of damage in the voltage detection connector 8B, as the protruding member, is suppressed.

Here, the deformation member 811 will be described.

### Bellows Shape

As in the deformation member 411 shown in FIGS. 11A and 11B, examples of the deformation member 811 include a bellows-shaped and hollow prismatic member. As a result of the deformation member 811 being bellows-shaped, even in a case in which an impact is applied to the battery module 10D from the direction of arrow A1 and the voltage detection connector 8B collides with the housing member 41, the bellows-shaped part of the deformation member 811 is compressed and deforms. As a result, the impact due to the collision between the voltage detection connector 8 and the housing member 41B is mitigated.

Note that the aspect in which the deformation member 811 is a bellows-shaped member is not limited to a bellows-shaped and hollow prismatic member. For example, as in the deformation member 411 shown in FIGS. 12A and 12B, the deformation member 811 may be a member being bellows-shaped and hollow and having no wall on the electrode laminate 2 side.

### Elastic Body

Further, examples of the deformation member 811 include an elastic body. As a result of the deformation member 811 being an elastic body, even when an impact is applied to the battery module 10D from the direction of arrow A1 and the voltage detection connector 8B collides with the housing member 41, the elastic body as the deformation member 811 is compressed owing to elastic deformation, and the impact caused by the collision between the voltage detection connector 8B and the housing member 41 is mitigated.

Examples of the elastic body include rubber and thermosetting elastomers. Examples of the rubber and the thermosetting elastomer include those listed as examples of the rubber and the thermosetting elastomer in the deformation member 411 of the third aspect.

### (Electrode Body)

Examples of the electrode body configuring the battery module according to the embodiment of the present disclosure include an electrode laminate. The electrode laminate is configured by plural electrodes layered via a separator. The electrode may have, for example, a laminate body of plural bipolar electrodes.

### (Applications)

Examples of the use application of the battery module according to the embodiment of the present disclosure include power supplies for hybrid vehicles (HEVs), plug-in hybrid vehicles (PHEVs), and electric vehicles (BEVs), for example.

What is claimed is:

1. A battery module, comprising:
an electrode body;
a housing that covers a periphery of the electrode body;
a protruding member that is disposed protruding from the electrode body and that is interposed in the housing; and
an impact mitigation part at a position at which the housing and the protruding member face each other, the impact mitigation part mitigating an impact caused by a collision between the housing and the protruding member.

2. The battery module of claim 1, wherein the housing has, as the impact mitigation part, a slide member that slides in an opposite direction from a side of the protruding member at a time at which the housing and the protruding member have collided.

3. The battery module of claim 1, wherein the protruding member has, as the impact mitigation part, a slide member that slides in an opposite direction from a side of the housing at a time at which the housing and the protruding member have collided.

4. The battery module of claim 1, wherein the housing has, as the impact mitigation part, a deformation member that deforms in an opposite direction from a side of the protruding member at a time at which the housing and the protruding member have collided.

5. The battery module of claim 1, wherein the protruding member has, as the impact mitigation part, a deformation member that deforms in an opposite direction from a side of the housing at a time at which the housing and the protruding member have collided.
